(19) United States
(12) Patent Application Publication
(10) Pub. No.: US 2011/0303790 A1
(43) Pub. Date: Dec. 15, 2011

(54) FRAME FOR A FLIGHT PASSENGER SEATING ROW

(75) Inventors: Frank ISELE, Horgenzell (DE); Ulf SOETEBIER, Friedrichshafen (DE)

(73) Assignee: Zim GmbH, Markdorf (DE)

(21) Appl. No.: 13/160,779

(22) Filed: Jun. 15, 2011

Related U.S. Application Data
(63) Continuation of application No. PCT/EP2009/008991, filed on Dec. 15, 2009.

(30) Foreign Application Priority Data
Dec. 16, 2008 (DE) 10 2008 062 113.7

(51) Int. Cl. B64D 11/06; B60N 2/68

(52) U.S. Cl. 244/118.6

(57) ABSTRACT

A frame for a flight passenger seating row having a front support structure and a rear support structure connected by means of at least one seat divider and at least one transverse beam. The seat divider(s) and the transverse beam(s) is/are easily releaseably connected to the front and/or rearsupport structure.

### CROSS REFERENCE TO RELATED APPLICATIONS

This application is a continuation of International Application No. PCT/EP2009/008991 filed Dec. 15, 2009, which designated the United States, and claims the benefit under 35 USC §119(a)-(d) of German Application No. 10 2008 062 113.7 filed Dec. 16, 2008, the entireties of which are incorporated herein by reference.

### FIELD OF THE INVENTION

The invention relates to a frame for a flight passenger seating row having a front support structure and a rear support structure connected by means of at least one seat divider and at least one transverse beam.

### BACKGROUND OF THE INVENTION

The frame of a flight passenger seat in economy class generally consists of a front support structure and a rear support structure, which are connected together via one or more seat dividers and seat feet to a supporting tube frame. The seat divider subdivides the supporting tube frame into individual seats. In this case, different possibilities are known for securing the individual components to one another. DE 39 18 500 A1 discloses the closest prior art of such a connection. In this application, the rear and front support structures are connected from above via a seat divider. The connection to the rear support structure is carried out, therefore, via a tensioning strap which is wrapped around said connection. In each case, a foot grips from below onto the front and rear support structure. Said foot is connected to a seat rail extending on the floor. In this case, the connection of the front foot to the front support structure is fixed in terms of rotation and the connection of the rear foot to the rear support structure is configured so that a movement about the axis of the rear support structure is permitted. With this construction, a support structure for seats of different widths may be used, but for unplanned modifications, depending on requirements, the design of the above-described connection of the individual components is too complicated.

### SUMMARY OF THE INVENTION

The object of the present invention is to provide a frame for flight passenger seats and flight passenger seating rows, all possible seating configurations and spacings of the seat feet and seat dividers relative to one another being able to be implemented in a simple manner.

The object is achieved by the seat divider(s) and the transverse beam(s) being easily releaseably connected to the front and/or rear support structure.

The support structures are preferably configured in a tubular manner as a support member, which for example has a groove-shaped profile, or as an actual supporting tube. In this case, the inventive idea also encompasses the formation of a support structure made up of two thin tubes which are adjacent or superimposed on top of one another.

Transverse beams and seat dividers are arranged on these support structures so that they may be displaced along the support structure, at least to a certain extent, but preferably over the entire length.

According to the design of the support structure, the seat dividers and transverse beams comprise elements which bear fully or partially against the periphery of the support structure. According to the exemplary embodiment, the encompassing of this periphery may be sufficient in order to produce a non-positive and/or frictional clamped connection to the support structure.

In a preferred exemplary embodiment, the support structures are formed from custom-made extruded profiles. In this case, one support structure has two profile-like convex portions or concave portions, which preferably oppose one another, of which one serves to support the seat divider and the other to support the transverse beam. In this case, the profiles may be formed to the side or above and below on the support structure. The convex portions or concave portions extend preferably, but not necessarily, over the entire length of the support structure. The seat dividers and transverse beams in each case have clamping, complementary elements, corresponding to the associated concave portion or convex portion thereof. Seat dividers and transverse beams may be displaced with the clamping elements to any position along the support structure.

In other exemplary embodiments, by simply encompassing the periphery or parts thereof it is not possible to achieve a sufficient connection of the transverse beams and seat dividers to the support structure, which is why further elements for securing to the support structure are assigned to the transverse beams and seat dividers.

In this case, according to a further very preferred exemplary embodiment, the additional elements may be connected via easily releasable connections, such as for example screw connections, to the seat dividers and transverse beams and/or the elements integrally formed thereon, which already partially encompass the support structure.

Moreover, for securing the seat dividers and transverse beams to the support structures, there is also the possibility of using clamping elements, such as for example clamps or the like.

In a further preferred exemplary embodiment, in which the support structure is formed from two individual tubes, it is provided to secure the transverse beams to the lower tube and the seat dividers to the upper tube. In adjacent tubes, the association may be made according to the spatial conditions and peripheral components, such as for example cable ducts, storage space or the like.

In principle, the disclosed connections have the advantage that transverse beams and seat dividers may be attached at the desired points to the support structures, independently of rails or bore holes which are present. As a result, it is possible to attach the seat dividers and transverse beams at any distances from one another.

It is additionally common to all known exemplary embodiments that transverse beams and seat dividers are applied to the support structure in two planes and/or from two sides. As a result, a specifically two-part connection has the advantage that a certain desired inherent flexibility of the support tube is permitted. This inherent flexibility is evident, particularly advantageously in combination with the seat dividers and seat feet which are formed from half-shells and which are disclosed in German Application Number 10 2008 039 261.8.

### BRIEF DESCRIPTION OF THE DRAWINGS

Further advantages, features and details of the invention are revealed from the following description of preferred exemplary embodiments and with reference to the drawings.

FIG. 1 shows a perspective view of a partially shown frame according to the invention of a row of flight passenger seats;

FIG. 2 shows a plan view of an enlarged detail of the frame according to the invention according to FIG. 1;

FIG. 3 shows a perspective view of a further exemplary embodiment of a partially shown frame according to the invention of a row of flight passenger seats;

FIG. 4 shows a perspective view of an enlarged detail of the frame according to the invention according to FIG. 3; and

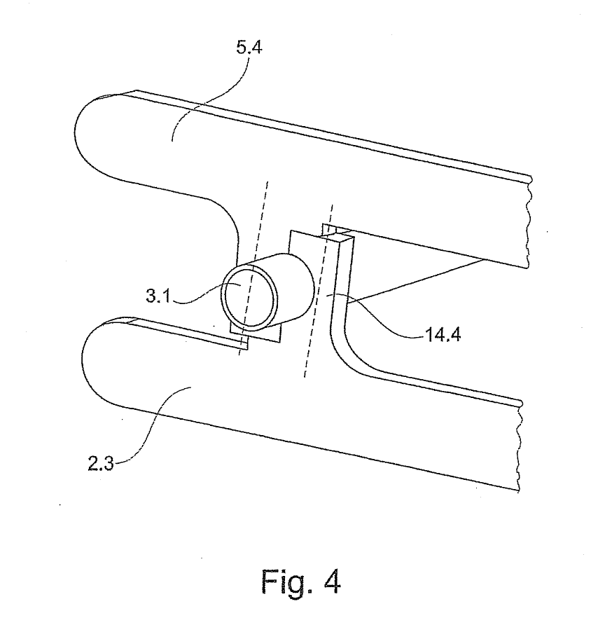

FIG. 5 shows a perspective view of a further exemplary embodiment of a partially shown frame according to the invention of a row of flight passenger seats.

### DETAILED DESCRIPTION OF THE INVENTION

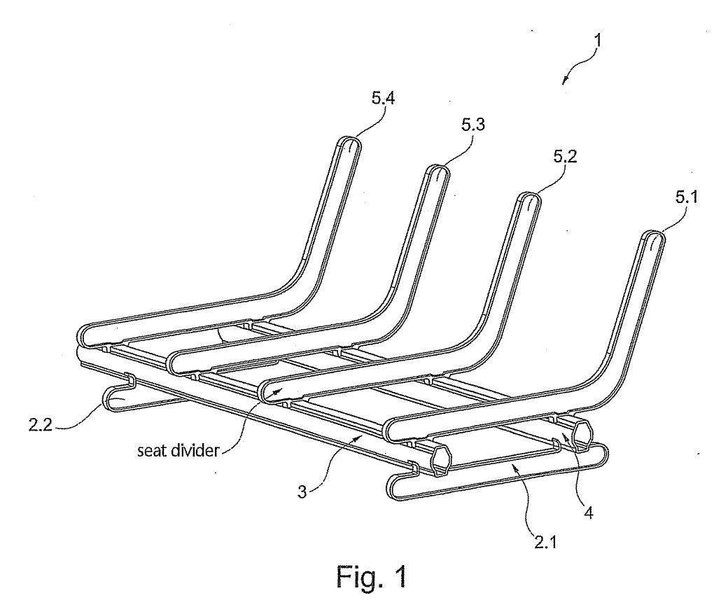

FIG. 1 shows parts of a frame 1 according to the invention for flight passenger seats in a row. Said frame 1 has two transverse beams 2.1 and 2.2. Seat feet, not shown, are attached thereto. A front support member 3 and a rear support member 4 are fastened to the transverse beams 2.1 and 2.2. Attached to the front support member 3 and the rear support member 4 are seat dividers 5.1, 5.2, 5.3 and 5.4 which subsequently receive the seat shells or seat surfaces.

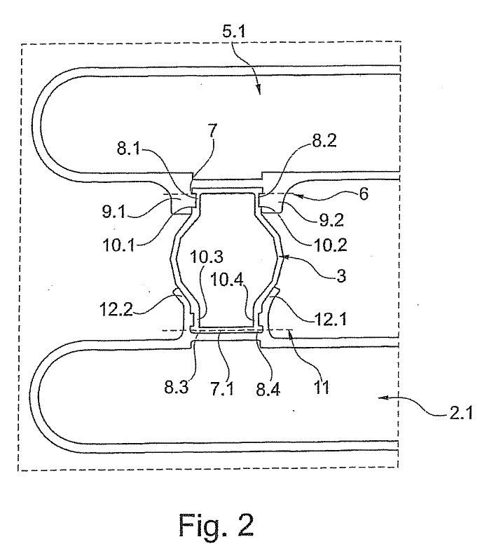

As shown in enlarged detail in FIG. 2, the seat divider 5.1 is connected in an upper fastening plane 6 to the front support member 3.

To this end, the front support member 3 in its upper region has a rail-shaped profile 7 in which lateral grooves 8.1 and 8.2 are formed. The rail-shaped profile 7 is encompassed by fastening lugs 9.1 and 9.2 of the seat divider 5.1. In this case, projections 10.1 and 10.2, which are integrally formed on the fastening lugs 9.1 and 9.2 engage in the lateral grooves 8.1 and 8.2 of the rail-shaped profile 7 of the front support member 3. The connection of the further seat dividers 5.2 to 5.4 to the front support member 3 and the seat dividers 5.1 to 5.4 to the rear support member 4 takes place in the same manner.

The transverse beam 2.1 is fastened in a lower fastening plane 11 to the support member 3. To this end, the support member 3 also has on its lower face a rail-shaped profile 7.1 with lateral grooves 8.3 and 8.4 corresponding to the profile 7 on the upper face. Clamps 12.1 and 12.2 which have projections 10.3 and 10.4 are integrally formed on the transverse beam 2.1. The clamps 12.1 and 12.2 encompass the profile 7.1 from outside and, therefore, the projections 10.3 and 10.4 engage in the lateral grooves 8.3 and 8.4 of the rail-shaped profile 7.1. The connection to the rear support tube 4 and the connection of the transverse beam 2.2 to the front and rear support members 3 and 4 takes place in the same manner.

The operation of the present invention is as follows:

By the arrangement according to the invention of the transverse beams 2.1 and 2.2 on the support members 3 and 4 any desired spacing of the transverse beams 2.1 and 2.2 relative to one another may be set. To this end, the transverse beams 2.1 and 2.2 are inserted in floor rails with the seat feet arranged thereon, and the support members 3 and 4 then mounted thereon. To this end, initially the support member 3 is pushed with its profile 7.1 between the clamps 12.1 and 12.2 of the transverse beam 2.1. The projections 10.3 and 10.4 then engage in the lateral grooves 8.3 and 8.4 of the rail-shaped profile 7.1. The support member 3 is connected to the transverse beam 2.2 and also the support member 4 is connected to both transverse beams 2.1 and 2.2 in the same manner.

When the transverse beams 2.1 and 2.2 are fixedly mounted on the support members 3 and 4, the seat dividers 5.1 to 5.4 may be mounted at the desired spacing on the support members 3 and 4. To this end, the fastening lugs 9.1 and 9.2 are pushed over the profile 7 until the projections 10.1 and 10.2 engage in the lateral grooves 8.1 and 8.2 of the profile 7.

Naturally, the frame may also be entirely or partially preassembled and then inserted with the seat feet into the corresponding floor rails.

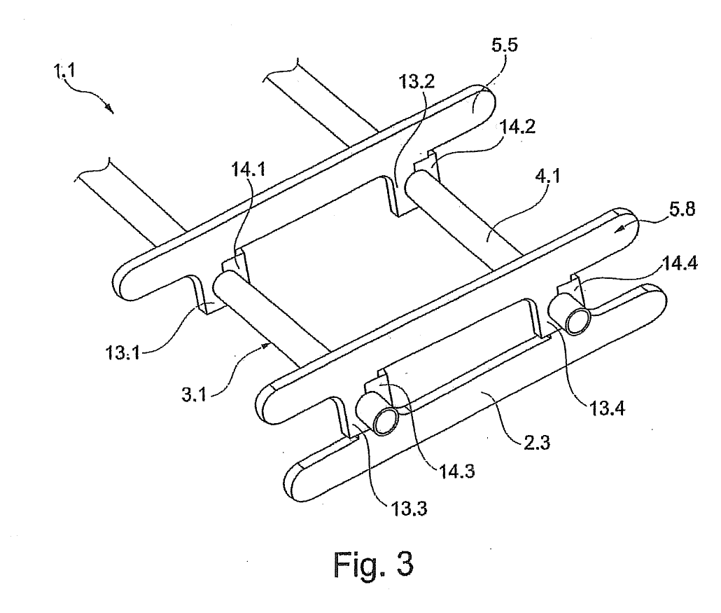

In a further exemplary embodiment according to FIG. 3, a frame 1.1 according to the invention is also constructed from a transverse beam 2.3, which is shown, and a transverse beam, which is not shown, seat dividers 5.8, 5.5 and a front support member 3.1 and a rear support member 4.1. The support members 3.1 and 4.1 are designed as tubes. In each case, two clamp elements 13.1, 13.2 and/or 13.3 and 13.4 are integrally formed on the seat dividers 5.8 and 5.5.

For securing the seat dividers 5.8 and 5.5 to the support members 3.1 and 4.1, mating elements 14.1 to 14.4 are assigned to the clamp elements 13.1 to 13.4 and connected together via a screw connection, not shown. In this case, the seat dividers 5.8 and 5.5 may be arranged at any distance from one another. Whilst the mating elements 14.1 and 14.2 are independent elements, the mating elements 14.3 and 14.4 are integrally connected to the transverse beam 2.3.

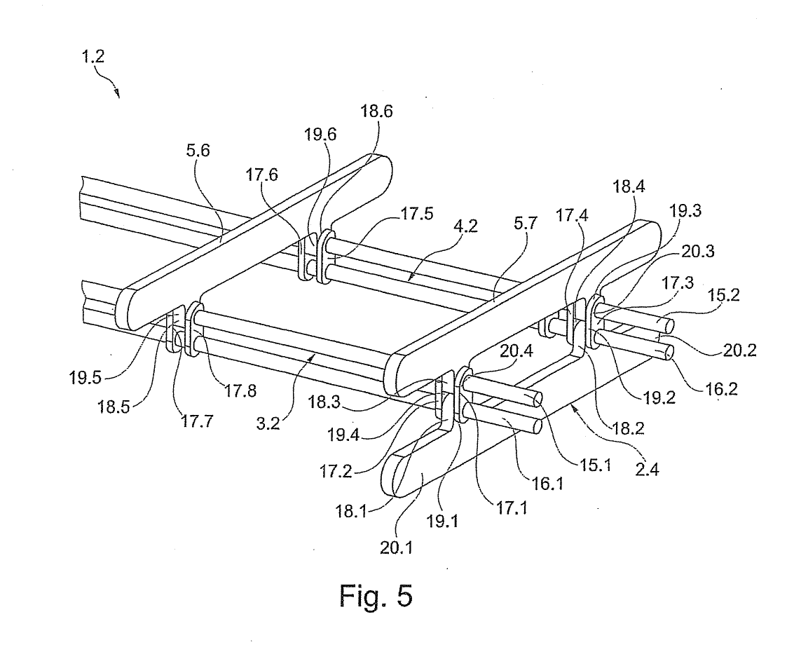

FIG. 5 shows a further exemplary embodiment according to the invention of a partial frame 1.2 which, according to the previous exemplary embodiments, has a front support structure 3.2 and a rear support structure 4.2, seat dividers 5.6 and 5.7 and a transverse beam 2.4, which is shown, and a further transverse beam, which is not shown.

In the present exemplary embodiment, the support structures 3.2 and 4.2 in each case are formed by an upper support tube 15.1 and 15.2 and a lower support tube 16.1 and 16.2 and connected via double clamps 17.1-17.8.

On the seat dividers 5.6 and 5.7 and the transverse beam 2.4, in each case two annular elements 18.1-18.6 which comprise openings 19.1-19.6 are integrally formed.

The mode of operation of the invention in the present exemplary embodiment is as follows:

For mounting the frame 1.2, initially the support tubes 15.1 and 16.1 are connected to the double clamp 17.1 and the support tubes 15.2 and 16.2 are connected to the double clamp 17.3. The double clamps 17.1-17.8 may be non-positively and positively secured via a tensioning or clamping mechanism, not shown. To this end, the lower support tubes 16.1 and 16.2 in each case are guided through a lower opening 20.1 and 20.2. The upper support tubes 15.1 and 15.2 are guided through the upper openings 20.3 and 20.4.

Then the seat divider 5.1 with the openings 19.4 and 19.3 of its annular elements 18.4 and 18.3 is pulled over the two upper support tubes 15.1 and 15.2.

In the next step, the transverse beam 2.4 with the openings 19.1 and 19.2 in its annular elements 18.1 and 18.2 is pulled over the lower support tubes 16.1 and 16.2. The seat support 4.2 and the transverse beam 2.4 may then be secured by the double clamps 17.2 and 17.4 in the desired position. The seat support 17.6 is mounted in a similar manner.

### LIST OF REFERENCE NUMERALS

1 Frame
2 Transverse beam
3 Front support member
4 Rear support member
5 Seat divider
6 Upper fastening plane
7 Profile
8 Lateral groove
9 Fastening lug
10 Projection
11 Lower fastening plane
12 Clamp
13 Clamp element
14 Mating element
15 Supporting tube top
16 Supporting tube bottom
17 Double clamp
18 Annular element
19 Opening
20 Opening

1. A frame for a flight passenger seating row having a front support structure and a rear support structure connected by at least one seat divider and at least one transverse beam, wherein the seat divider and the transverse beam are easily releaseably connected to at least one of the front and rear support structures, respectively.

2. A frame according to claim 1, wherein the seat divider and the transverse beam are arranged displaceably on the front support structure and rear support structure, respectively.

3. A frame according to claim 1, wherein the front support structure and the rear support structure are configured in a tubular manner as support members or supporting tube.

4. A frame according to claim 3, wherein at least one seat divider is connected in an upper fastening plane to the support members.

5. A frame according to claim 3, wherein at least one transverse beam is connected in a lower fastening plane to the support members.

6. A frame according to claim 3, wherein the support members have rail-shaped profiles for forming the fastening plane, over at least one part of their length.

7. A frame according to claim 6, wherein at least one seat divider comprises fastening lugs which are able to be guided over the rail-shaped profile and are able to be inserted into lateral grooves.

8. A frame according to claim 6, wherein at least one transverse beam comprises clamps for fastening to the rail-shaped profile.

9. A frame according to claim 8, wherein the clamps engage with projections in lateral grooves for fastening to the rail-shaped profile.

10. A frame according to claim 5, wherein at least one seat divider comprises clamp elements with semi-circular recesses, which bear against the support members.

11. A frame according to claim 10, wherein at least one transverse beam comprises mating elements with semi-circular recesses.

12. A frame according to claim 11, wherein the mating elements bear with one surface against the clamp elements.

13. A frame according to claim 10, wherein mating elements are assigned to the clamp elements.

14. A frame according to claim 1, wherein the front and rear support structures in each case are formed from an upper supporting tube and a lower supporting tube.

15. A frame according to claim 14, wherein at least one seat divider is connected to the upper supporting tubes.

16. A frame according to claim 15, wherein at least one transverse beam is connected to the lower supporting tubes.

17. A frame according to claim 16, wherein at least one transverse beam comprises annular elements with openings.

18. A frame according to claim 17, wherein at least one transverse beam with the openings is able to be placed over the lower supporting tubes.

19. A frame according to claim 15, wherein at least one seat divider comprises annular elements with openings.

20. A frame according to claim 19, wherein at least one seat divider with its openings may be placed over the upper supporting tubes.
